(19) United States
(12) Patent Application Publication
(10) Pub. No.: US 2014/0258425 A1
(43) Pub. Date: Sep. 11, 2014

(54) Method and Device for Long Lived Chat with Dynamic Focus

(71) Applicant: Infinite Convergence Solutions, Inc., Arlington Heights, IL (US)

(72) Inventor: Geoffrey Dietz, Hoffman Estates, IL (US)

(21) Appl. No.: 14/195,819

(22) Filed: Mar. 3, 2014

Related U.S. Application Data
(60) Provisional application No. 61/775,505, filed on Mar. 9, 2013.

(51) Int. Cl. H04L 12/58

(52) U.S. Cl. CPC H04L 51/04
USPC 709/206

(57) ABSTRACT

This provides a method and message server device to allow restart of an inter-carrier chat session using a local chat server even if the same session was previously started on another carrier's conference focus server.

### CROSS-REFERENCE TO RELATED APPLICATIONS

This application claims the benefit of U.S. Provisional Application 61/775,505 filed on Mar. 9, 2013 by the present inventor which is incorporated by reference into this application.

### FEDERALLY SPONSORED RESEARCH

None

### SEQUENCE LISTING

None

### FIELD OF THE INVENTION

This relates to a method and device which allow restart of an inter-carrier chat session hosted by a local chat server even if the session was originally started on another carrier's chat server.

### BACKGROUND OF THE INVENTION

The RCS 5 as well as the OMA CPM telecommunication standards allow an inter-carrier group chat participant to restart a previously existing group chat session. This is known as a “long lived” chat session. This standard method uses a Join SIP protocol INVITE method to the original controlling function for the long lived chat session to restart the chat session. This can only be done with the “conference focus” IM Server that is maintaining the participant list. In an inter-carrier scenario, as per current standards, the conference focus that hosts the chat maintains the list at the beginning and throughout the session, as well as after the session is restarted.

For billing reasons as well as a desire to restrict initiation of use of network resources to only their own customers, in inter-carrier situations many carriers desire to have the restart of the chat session done within the same network as the client requesting the restart of the session. Under current standards, however, the restart of the long lived session is done by the original conference focus, regardless of the home carrier of the client requesting the restart of the session. This often results in server resources in one network being requested by a client of another network which many carriers find undesirable.

One known workaround is for every client to maintain a list of all participants in the chat and allowing each (nonstandard) client to restart the session themselves based upon information stored at the client. This method requires the cooperation of various providers of the clients, usually many different handset providers. This is also not desirable as storing extra information at the client requires extra network bandwidth passing participants lists needlessly between clients in order to allow each client to maintain a participant list locally. There also scenarios where the participant list can get out of sync with other clients. This client-based restart of the session can also cause other problems in the network, since, for a carrier that has multiple local IM servers, the Long Lived Chat Session may not be restarted at the same IM Server every time, leading to inefficiencies as multiple servers may have stored messages for the same subscriber related to the same Long Lived Chat Session.

What is needed is a way to restart the session local to the requesting client without the client being modified to maintain the chat participant list.

That is the problem solved by this inventor.

### SUMMARY OF INVENTION

It is desirable to allow each telecommunication service carrier to restart a Long Lived Group Chat session in the local carriers network when a local subscriber attempts to restart or reestablish an inactive Long Lived Group Chat session. Currently it is required that the original focus in the foreign network be used to restart the session. This invention defines a method for the local IM Server to directly restart the session.

This uses the local IM Server (or participant function) to record the participant list on behalf of the local subscriber when the Long Lived Group Chat originated in another carrier's (a.k.a. “foreign”) network. The local IM Server in this case will act as a back to back UA (B2BUA) and look like the local subscribers to the session started in another carrier's server. The Local IM Server presents the session to the user as a session directly handled at the local server. Specifically the Contact address for the session is the local servers address (and Session ID). The local IM Server will link this to the Contact address and session ID received from the foreign server. This information is maintained after the active session ends to allow the local subscriber to restart the Long Live Group Chat session. During the session the local IM Server is reported at the controlling function for the session. So, in the preferred embodiment, the local subscriber uses the SIP protocol and sends the join INVITE request to restart the Long Lived Chat Session to the local IM Server (this can work with the IM Server handling both the controlling function and participating functions or treating these as separate entities in the network). The IM Server can then use the previously stored session information including the participant list to restart the session with the local IM Server acting as the controlling function for the session, thus replacing the other carrier's server as the host for the restarted chat session.

A method is also provided to link a locally restarted Long Lived Chat Session back to the original Controlling network for the session allowing any participant list changes in the new session to be reflected in the original controlling network.

### DRAWINGS

### List of Reference Numbers

101 Shows a mobile client that is homed on a remote carrier
102 A second mobile client that is homed on a remote carrier
103 Mobile client that is homed on the local carrier.
110 IM Server that is remote carrier network.
120 IM Server that is in home carrier network.
190 Inter-carrier logical boundary
   440 Second IM Server that is in home carrier network.

### GLOSSARY

B2BUA Back to Back User Agent
CLIENT Software that accesses a remote server
Conference Focus A specialized User Agent that processes chat invitations and maintains dialogs with each chat participant. Usually this is a dedicated server and in inter-carrier scenarios the conference focus can maintain dialogs across telecommunications carriers.
CPM Converged IP Messaging protocol for messaging
Foreign Not under control of the local telecommunications provider.
IETF Internet Engineering Task Force
IM Instant Message
IP Internet Protocol
OMA The Open Mobile Alliance is a standards body which develops open standards for the mobile phone industry.
RCS Rich Communications Suite
RFC IETF Request for Comments Document
SIP Session Initiation Protocol
UA User Agent. In RFC 3261 the term UA refers to both end points of a communications session
URI Uniform Resource Identifier—A string of characters used to identify a name or a web resource. Such identification enables interaction with representations of the web resource over a network using specific protocols.

### BRIEF DESCRIPTION OF DRAWINGS

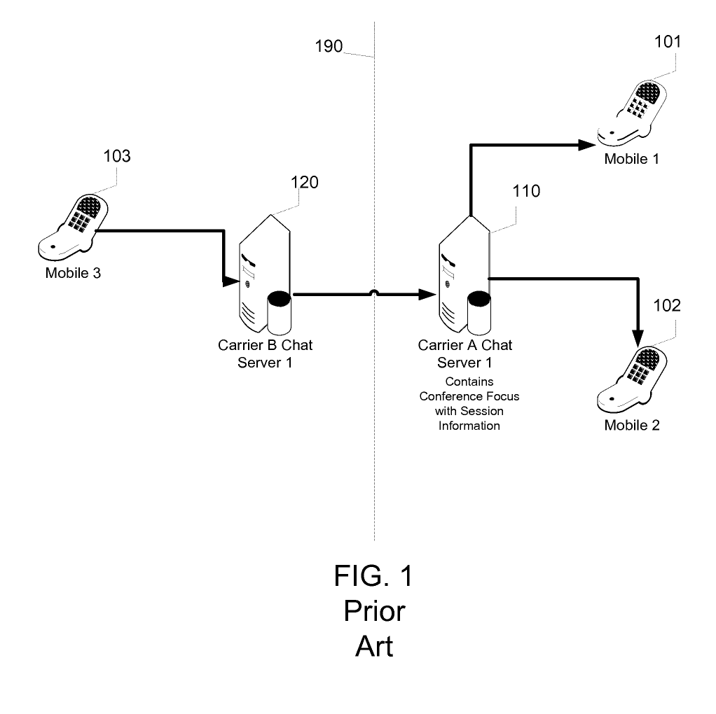

FIG. 1 shows the prior art where mobile 3 requests to restart a previous chat session with mobiles 1 and 2 which are on another network. When Mobile3, located on carrier B attempts to join the session that is no longer active, the request must be forwarded to server in Carrier A to restart the session.

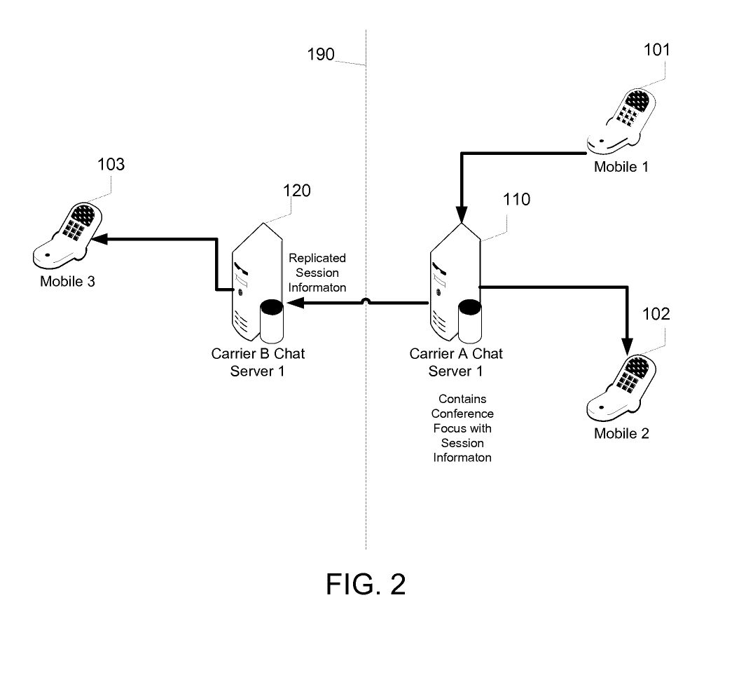

FIG. 2 shows starting a session using the newly invented dynamic focus method. At session startup, the Carrier B IM Server records the Session Info. In the preferred embodiment this is from the SIP INVITE and also uses SUBSCRIBE/NOTIFY to get the correct participant list for the session, so that session can be restarted locally by carrier B's server. This information is readily available when acting as a back to back user agent (B2BUA) on behalf of the local subscriber.

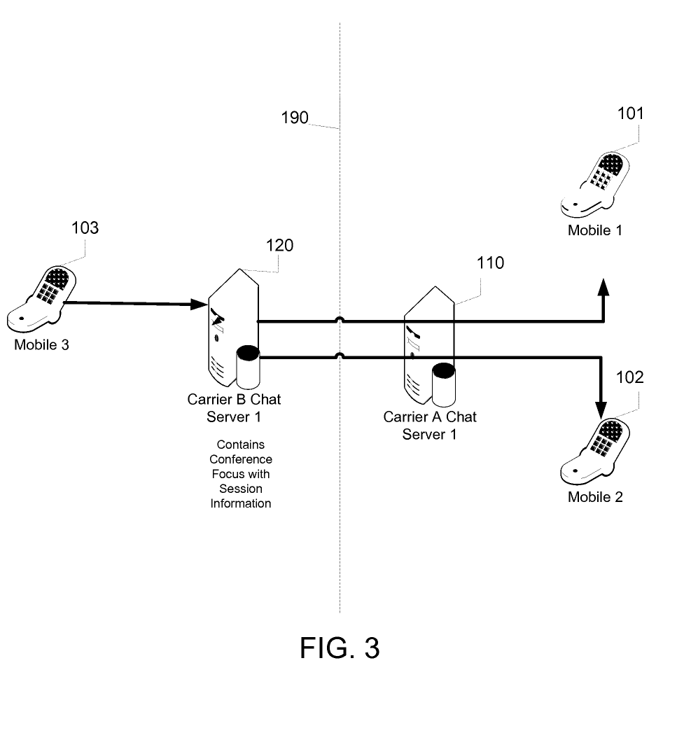

FIG. 3 shows mobile 3 initiating a restart of the session with the newly invented dynamic focus method. When Mobile3 attempts to join the session that is no longer active, the local IM Server uses the recorded session information to restart the session directly. Mobile1 and Mobile2 are still invited through the other carrier's IM Server, but Carrier B, not Carrier A is the controlling function for the restarted session.

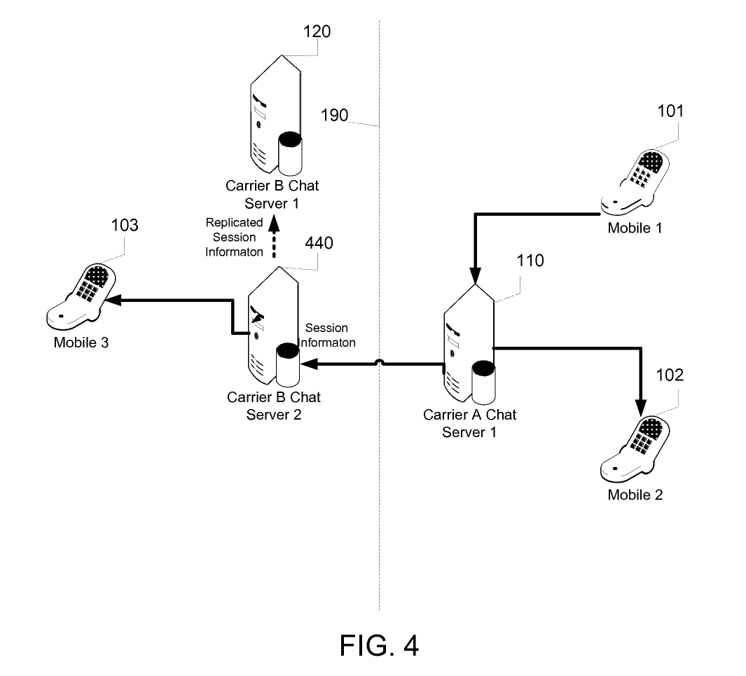

FIG. 4 shows a restart of the session at the request of a client on the other carrier.

Long Lived sessions may also be restarted in the original home network (Carrier A). If Carrier B has multiple IM Servers that session may be restarted through a different IM Server. The figure shows the session information being replicated to another server in the Carrier B network so that all IM Servers in Carrier B network that may have previously handled this Long Lived Chat session is kept up to date with the latest session information for the session. This replication is useful in case the local subscriber later attempts to restart the session at a different server in Carrier B's network that previously processed an active session for this long lived chat session.

### DETAILED DESCRIPTION

This uses the local IM Server (or participant function) to record the participant list on behalf of the local subscriber when the Long Lived Group Chat originated in another carrier's (a.k.a “foreign”) network. The local IM Server in this case will act as a back to back UA (B2BUA) and look like the local subscriber to the session started in another carriers server. The Local IM Server presents the session to the user as a session directly handled at the local server. In the preferred embodiment the Contact address for the session is the local servers address (and SESSION ID). In another embodiment, the contact address for the session is the address of the target CPM Group Session of CPM Long-live Group Session. In the preferred embodiment, the local IM Server will link this to the Contact address and session ID received from the foreign server. This information is maintained after the active session ends to allow the local subscriber to restart the Long Live Group Chat session. During the restarted session the local IM Server is reported as the controlling function for the session. Any requests from the local subscriber to restart this Long Lived Chat session the request will go to the local server, because when the original active session was setup to the subscriber, the local server was reported as the controlling functions for the session. In this case the local IM Server is the real controlling function for the restarted active session.

In the preferred embodiment, using the SIP protocol,

The local IM Server uses the participant list reported to the client in the NOTIFY messages to maintain the active participant list for the session. This information is maintained after the active session ends. The local subscriber will send the join INVITE request to restart the Long Lived Chat Session to the local IM Server (this can work with the IM Server handling both the controlling function and participating functions or treating these as separate entities in the network). The IM Server uses the previously stored session participant list to restart the session with the local IM Server acting as the controlling function for the session. If there are any changes to the session information (e.g. change to participant list) after the session is restarted by the local server, that session information is fed back to the original carrier's IM Server because the foreign network subscribers for the chat session are invited to the new active session using the Contact address of the Controlling Function in the foreign network that is the original controlling function for the session. The form of the SIP INVITE in this cases is not a join INVITE to restart the original session, but is the form of the INVITE for the controlling function to invite a single recipient to an chat session. The foreign network IM Server in this case is acting as the local IM Server for the foreign network recording and updating the session information and participant list for the long lived change session actively being controlled in the other network. In addition, if the local carrier has multiple IM servers, the session information should be shared with the other local servers so that local clients may restart the session on any local IM server (as shown in FIG. 4).

What is claimed is:

1. A method to provide dynamic hosting of an inter-carrier chat session comprising:
a. A local message server receiving a chat invitation on behalf of a local client for a chat session being hosted on another carriers network;
b. storing session information on the local message server;
c. the message server forwarding the chat invitation to the local client or clients invited to the chat session;
d. the message server forwarding any replies from the local client or clients to the other carrier's conference focus;
e. the session being suspended;
f. the local message server restarting the above chat session at the request of a local client.

2. The method of claim 1 additionally comprising the local message server providing an update of the session information to the other carrier's conference focus.

3. The method of claim 1 where the session information on the local message server comprises the participant list of other clients in the chat session.

4. The method of claim 1 where the session information comprises the session identifier.

5. The method of claim 1 where the session information comprises the address of the target CPM Group Session of the CPM Long-live Group Session.

6. A message server which comprises session information for chat sessions hosted on another carriers network sufficient to provide local hosting of an inter-carrier chat session.

7. The server of claim 6 comprising a means to replicate and update the session information to other local servers.

8. The server of claim 6 where the session information comprises the session identifier.

9. The server of claim 6 where the session information comprises the address of the target CPM Group Session of the CPM Long-live Group Session.

10. The server of claim 6 comprising a means to locally restart the hosting of an inter-carrier chat session originally hosted using another carrier's conference focus.

11. The server of claim 6 which comprises a means to update the session information to the other carrier's conference focus.
